(19) United States
(12) Patent Application Publication
(10) Pub. No.: US 2014/0294370 A1
(43) Pub. Date: Oct. 2, 2014

(54) Image Blurring Avoiding Method and Image Processing Chip Thereof

(71) Applicant: NOVATEK Microelectronics Corp., Hsin-Chu (TW)

(72) Inventors: Chia-Ho Lin, Hsinchu County (TW); Shu-Han Yu, Taipei City (TW); Chih-Chih Huang, Hsinchu County (TW); Kai-Wen Wang, Taoyuan County (TW)

(21) Appl. No.: 13/928,399

(22) Filed: Jun. 27, 2013

(30) Foreign Application Priority Data
Mar. 28, 2013 (TW) 102111239

(51) Int. Cl. G02B 27/64

(52) U.S. Cl. CPC G02B 27/646
USPC 396/53; 396/55

(57) ABSTRACT

An image blurring avoiding method for a camera includes obtaining a motion data of the camera; and capturing a picture only when the camera is substantially motionless according to the motion data.

### BACKGROUND OF THE INVENTION

1. Field of the Invention

The present invention relates to an image blurring avoiding method and an image processing chip thereof, and more particularly, to an image blurring avoiding method and an image processing chip thereof capable of obtaining motion data of a camera so as to take a picture only when the camera is substantially motionless for avoiding image blurring due to shaky hands.

2. Description of the Prior Art

In general, in order to avoid image blurring when taking a picture, conventional technologies may utilize high-speed continuous shooting to achieve high dynamic range (HDR) shots or anti-shake for night shots. Alternatively, the conventional technologies may raise ISO and shorten an exposure time to avoid a movement in one single photo and then synthesize multiple photos for improving brightness, or may add accelerator sensor or digital anti-shake information to obtain a motion data and then crop to align different photos.

However, even though multiple photos are taken and then processed for anti-shake and image blurring by using the conventional technologies, the picture may still be blurred if the camera shakes during the time when one single photo is taken. Besides, currently CMOS image sensors are often used as the image sensors, and since a CMOS image sensor captures an image in a row-by-row manner, if the camera is moved during the exposure time, the picture maybe distorted due to the rolling shutter effect, and the distortion can not be compensated by cropping for visual angle alignment even if the picture is not blurred.

For example, please refer FIG. 1, which is a schematic diagram of an anti-shake process performed by a conventional camera. As shown in FIG. 1, the camera takes pictures P₁-P₅ at times T₁-T₅ for the anti-shake process, wherein the camera is substantially motionless at times T₁, T₃, T₅ but is moving at times T₂, T₄ due to shaky hands. In such a situation, even if the camera may use an accelerator sensor or digital anti-shake information to obtain a motion data and properly crop cropping areas CR₁-CR₅ in the pictures P₁-P₅ for alignment (i.e. detect that the camera is moved to the left side at times T₂, T₃ due to shaky hands so that the contents of the pictures P₂, P₃ are shifted to the right, and the camera is moved to the right side at times T₄, T₅ due to shaky hands so that the contents of the pictures P₄, P₅ are shifted to the left), the pictures P₂, P₄ and corresponding cropping areas CR₂, CR₄ have been blurred due to shaky hands, and therefore the image obtained by aligning the cropping areas CR₁-CR₅ is still blurred.

Noticeably, if the camera utilizes a CMOS image sensor to sense images, pictures P₂′, P₄′ are taken at times T₂, T₄, wherein the camera is moved to the left side due to shaky hands so that the content of the picture P₂′ is skewed to the right for a top-down exposure, and the camera is moved to the right side due to shaky hands so that the content of the picture P₂′ is skewed to the left for a top-down exposure. Under such a condition, the cropping areas CR₂, CR₄ obtained by cropping pictures P₂′, P₄′ are skewed to the right and the left, respectively, and therefore cannot be aligned with the cropping areas CR₁, CR₃, CR₅.

From the above, if the camera suffers shaky hands when taking a single photo, it is unavoidable that the picture may be blurred. Also, the CMOS image sensor may distort the image due to the rolling shutter effect so that the distortion may not be compensated by cropping for visual angle alignment. Thus, there is a need for improvement of the prior art.

### SUMMARY OF THE INVENTION

It is therefore an objective of the present invention to provide an image blurring avoiding method and an image processing chip thereof capable of obtaining a motion data of a camera so as to take a picture only when the camera is substantially motionless for avoiding image blurring due to shaky hands.

The present invention discloses an image blurring avoiding method for a camera, comprising obtaining a motion data of the camera; and capturing a picture only when the camera is substantially motionless according to the motion data.

The present invention further discloses an image processing chip for a camera, for executing the above image blurring avoiding method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an anti-shake process performed by a conventional camera.

FIG. 2 is a schematic diagram of a camera according to an embodiment of the present invention.

FIG. 3 is a flow chart of an image blurring avoiding method of the camera shown in FIG. 2.

FIG. 4 is a schematic diagram of obtaining a picture based on preview frames by an image processing chip shown in FIG. 2

### DETAILED DESCRIPTION

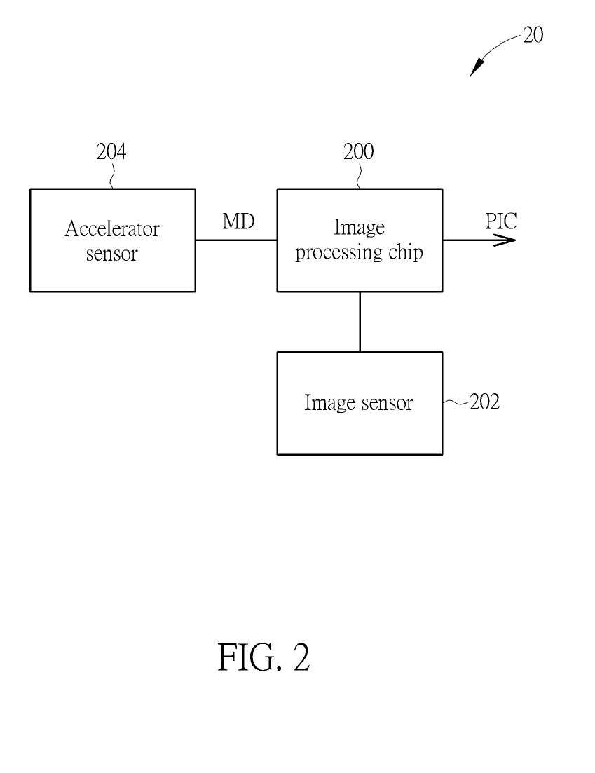

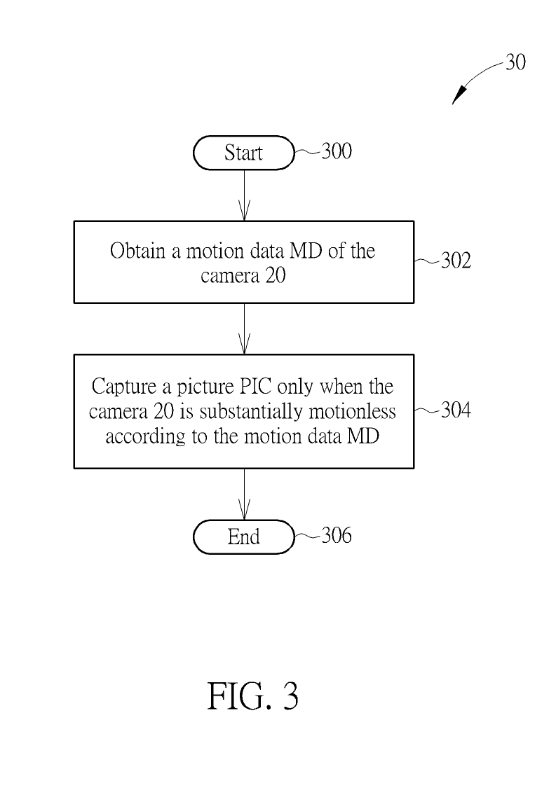

Please refer to FIG. 2 and FIG. 3. FIG. 2 is a schematic diagram of a camera 20 according to an embodiment of the present invention, and FIG. 3 is a flow chart of an image blurring avoiding process 30 of the camera 20. As shown in FIG. 2 and FIG. 3, the camera 20 includes an image processing chip 200 and an image sensor 202. The image sensor 202 may be a CMOS image sensor or a charge-coupled device (CCD). The image processing chip 200 is used for executing the image blurring avoiding process 30 to avoid image blurring due to shaky hands. The image blurring avoiding process 30 includes the following steps:

Step 300: Start.

Step 302: Obtain a motion data MD of the camera 20.

Step 304: Capture a picture PIC only when the camera 20 is substantially motionless according to the motion data MD.

Step 306: End.

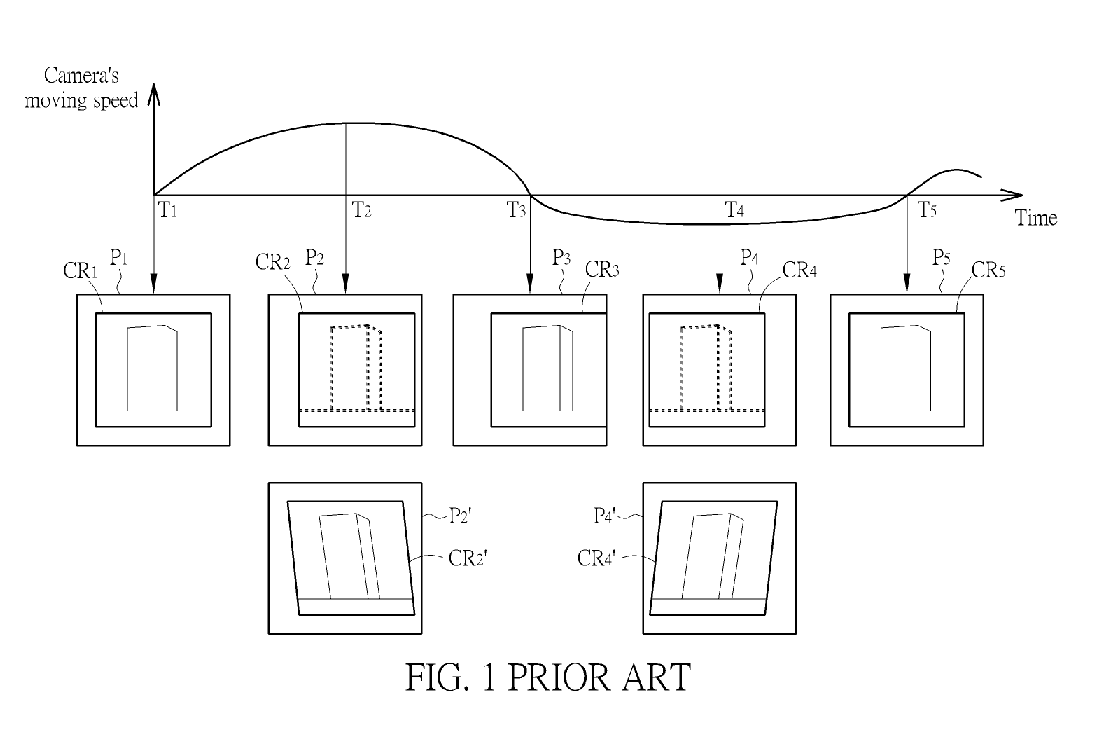

According to the image blurring avoiding process 30, the image processing chip 200 obtains the motion data MD (such as instantaneous speed) of the camera 20, and then controls the image sensor 202 to take the picture PIC for processing when the camera 20 is substantially motionless. Under such a situation, even if a user has pressed the shutter of the camera 20, the image processing chip 200 controls the image sensor 202 to take the picture PIC for processing only when the camera 20 is motionless (e.g. the times T₁, T₃, T₅ shown in FIG. 1) so that the picture PIC taken is not blurred due to shaky hands or distorted due to the rolling shutter effect (under a condition when the image sensor 202 is a CMOS image sensor). As a result, the present invention can obtain the motion data MD of the camera 20 so as to take the picture PIC only when the camera 20 is substantially motionless for avoiding image blurring due to shaky hands or image distortion due to the rolling shutter effect, and preventing image noise which is caused from shortening the exposure time and raising ISO in the prior art.

In detail, the image processing chip 200 may obtain the motion data MD of the camera 20 by various manners. In a first embodiment, the camera 20 may further include an accelerator sensor 204, which detects and provides the motion data MD such as the acceleration to the image processing chip 200 by hardware, so as to control the image sensor 202 to take the picture PIC for processing when the camera 20 is substantially motionless (e.g., when the acceleration detected by the accelerator sensor 204 is smaller than a threshold value, the image processing chip 200 determines that the camera 20 is substantially motionless and then takes the picture PIC according to a corresponding preview frame).

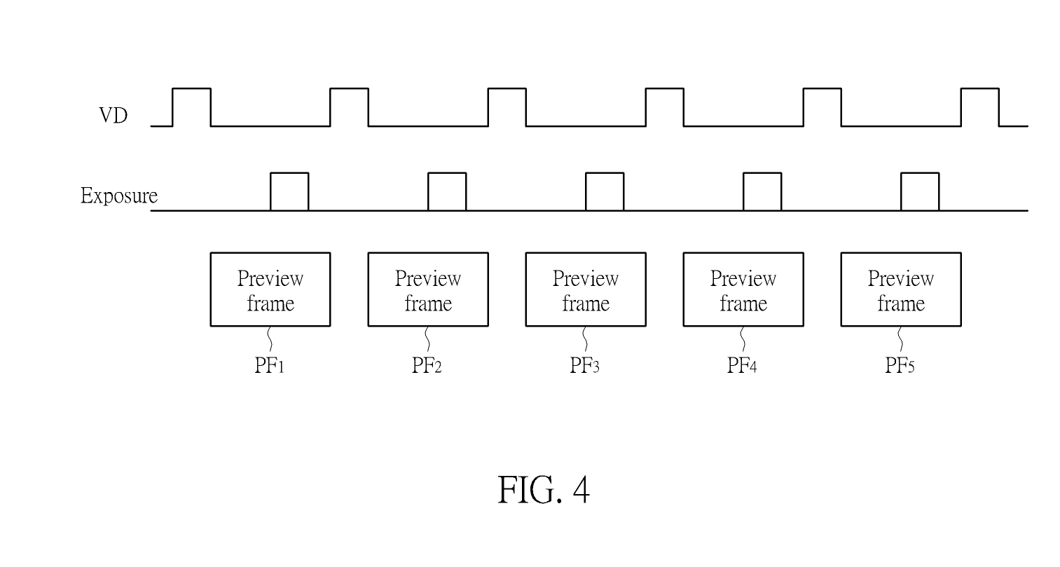

On the other hand, please refer to FIG. 4, which is a schematic diagram of obtaining the picture PIC according to preview frames PR₁-PR₅ by the image processing chip 200. As shown in FIG. 4, in a second embodiment, the image processing chip 200 captures preview frames PR₁-PR₅ according to a capturing clock VD (e.g. the capturing clock VD has a period of 1/30 second, and the image processing chip 200 obtains VGA preview frames PR₁-PR₅ with smaller file size by exposures in specific time points relative to the time when the capturing clock VD is with logic high). Then, by using a digital form such as the digital image stabilization (DIS) method, the image processing chip 200 obtains the motion data MD of the camera 20 according to a motion vector of two preview frames among the preview frames PR₁-PR₅ (i.e. determines an instantaneous speed between the two preview frames by using a motion vector of the two preview frames under a fixed cycle time), so as to control the image sensor 202 to take the picture PIC for processing when the camera 20 is substantially motionless (e.g. when the motion vector between the preview frames PR₃, PR₄ is smaller than a threshold value, the image processing chip 200 determines that the camera 20 is substantially motionless and then takes the picture PIC with larger file size according to the corresponding preview frame PF₄).

Note that in the above embodiments, the motion data MD of the camera 20 is obtained, so as to take the picture PIC when the camera 20 is substantially motionless for avoiding image blurring due to shaky hands or image distortion due to the rolling shutter effect. Those skilled in the art can make modifications and alterations accordingly. For example, in the above-mentioned second embodiment, the VGA preview frames PR₁-PR₅ with smaller size are obtained by exposures in specific time points relative to the time when the capturing clock VD is with logic high, but in other embodiments, the accelerator sensor 204 of the first embodiment may be employed to adjust exposure time points relative to the time when the capturing clock VD is with logic high according to the motion data MD detected by the accelerator sensor 204 for capturing preview frames only when the camera is substantially motionless.

Besides, the image processing chip 200 may include a processing means and a storage unit. The processing means may be a microprocessor or an application-specific integrated circuit (ASIC). The storage unit may be any data storage device that can store a program code, accessed and executed by the processing means for the image processing chip 200 to realize the image blurring avoiding process 30 and related operations.

In the method of the conventional technologies that takes multiple photos and then processes for anti-shake, if the camera suffers shaky hands when taking a single photo, it is still unavoidable that the picture may be blurred. Also, since a CMOS image sensor captures an image in a row-by-row manner, if the camera is moved during the exposure time, the picture may be distorted due to the rolling shutter effect, and the distortion may not be compensated by cropping for visual angle alignment even if the picture is not blurred. In comparison, the present invention obtains the motion data MD of the camera 20, so as to take the picture PIC only when the camera 20 is substantially motionless for avoiding image blurring due to shaky hands or image distortion due to the rolling shutter effect.

Those skilled in the art will readily observe that numerous modifications and alterations of the device and method may be made while retaining the teachings of the invention. Accordingly, the above disclosure should be construed as limited only by the metes and bounds of the appended claims.

1. An image blurring avoiding method for a camera, comprising:
obtaining a motion data of the camera, comprising detecting the motion data of the camera by an accelerator sensor disposed in the camera;
capturing a plurality of preview frames when the camera is substantially motionless according to the motion data detected by the accelerator sensor and a capturing clock; and
capturing a picture only when the camera is substantially motionless according to the motion data.

2-3. (canceled)

4. The image blurring avoiding method of claim 1, wherein the step of obtaining the motion data of the camera comprises:
capturing a plurality of preview frames according to a capturing clock; and
detecting the motion data of the camera according to a motion vector of two preview frames among the plurality of preview frames.

5. The image blurring avoiding method of claim 1, wherein the step of capturing the picture only when the camera is substantially motionless according to the motion data comprises:
determining that the camera is substantially motionless when the motion data is smaller than a threshold value.

6. The image blurring avoiding method of claim 1, wherein the step of capturing the picture only when the camera is substantially motionless according to the motion data comprises:
capturing the picture with a corresponding preview frame when the camera is substantially motionless.

7. An image processing chip for a camera, for executing the image blurring avoiding method of claim 1.
